(19) United States
(12) Patent Application Publication
(10) Pub. No.: US 2003/0223463 A1
(43) Pub. Date: Dec. 4, 2003

(54) Method to improve fax transmission quality over packet based networks with significant delay and packet jitter using protocol re-timing

(76) Inventors: Mehrdad Abrishami, Gaithersburg, MD (US); Jianwei Bei, Rockville, MD (US)

Correspondence Address: LSI LOGIC CORPORATION, 1621 BARBER LANE, MS: D-106 LEGAL, MILPITAS, CA, 95035, US

(21) Appl. No.: 10/158,634

(22) Filed: May 30, 2002

(51) Int. Cl. H04J 3/06

(52) U.S. Cl. 370/516; 370/514

(57) ABSTRACT

A method and apparatus to improve fax quality when transmitting fax over packet based network with significant delay and packet jitter. The method is based on adjustment to the protocol timing between a “receiving Gateway” and the receiving Group 3 Facsimile Equipment (G3FE). The protocol adjustment is applied when operating facsimile transmission over Internet to increase the success rate for transmission of facsimile via T.38 or similar facsimile relay protocols. The method ensures that network delay and packet jitter do no result in certain violation of timing constraints defined by the T.30 protocol between a “receiving Gateway” and receiving G3 Fax Terminals.

### BACKGROUND

The present invention generally relates to fax transmissions over packet based networks, and more specifically relates to a method and apparatus for maintaining a fax transmission even though a data bottleneck exists somewhere between a source and destination fax machine, which might otherwise cause the fax transmission to cease due to excessive time delay brought about by the bottleneck.

In its T.30 and T.4 standards, the Telecommunications Standardization Section of the ITU (ITU-T) has defined procedures for facsimile transmission of documents in a public switched telephone network (PSTN). The T.30 and T.4 standards define a Group 3 facsimile service, also known as Group 3 FAX and G3 FAX. The recommendation is for a “Group 3 facsimile apparatus.” A Group 3 facsimile apparatus includes any one of (1) a facsimile machine, (2) a computer with a facsimile modem and corresponding software, and (3) other similar products. As referred to herein, the term “facsimile machine” or “fax machine” applies to any Group 3 facsimile apparatus.

The T.30 standard was written for a facsimile provided over a wired telephone network, a PSTN, or a digital encoding of the analog signal (e.g., using PCM). However, in a bandwidth-limited digital network or a packet network such as the Internet, other techniques are used to send a facsimile in real-time.

One method of supporting Group 3 FAX over bandwidth-limited digital network or a packet network, such as Internet, uses a facsimile relay system to (1) demodulate the analog facsimile signal, (2) transmit the digital data using the digital network or packet network, and (3) remodulate the signal at the other relay station to provide an analog signal. In such a system, in addition to demodulating and remodulating the facsimile signal, the T.30-based relay protocol is implemented in the relay gateways. ITU-T T.38 is one such T.30-based relay protocol specified for the IP network. T.38 specifies the messages and data exchanged between facsimile gateways connected via an IP network. Once the end-to-end connection is established, the protocol assumes a consistent end-to-end timing will exit. However, because of the delays introduced in facsimile relay processing as well as IP routing within Internet, this is not a correct assumption. Most facsimile machines are sensitive to the accuracy of timing within +/−20 milliseconds, and may drop the call if it is violated or take other actions that may result in the eventual failure of the facsimile relay transmission.

### OBJECT AND SUMMARY

A general object of an embodiment of the present invention is to provide a method and apparatus to improve fax quality when transmitting fax over packet based network with significant delay and packet jitter.

Another object of an embodiment of the present invention is to provide a method and apparatus for adjusting protocol timing between a receiving Gateway and the receiving Group 3 Facsimile Equipment (G3FE).

Still another object of an embodiment of the present invention is to provide a method and apparatus for adjusting protocol timing over Internet to increase the success rate for transmission of facsimile via T.38 or similar facsimile relay protocols.

Still yet another object of an embodiment of the present invention is to provide a method and apparatus for adjusting protocol timing to ensure that network delay and packet jitter do no result in violation of timing constraints defined by, for example, the T.30 protocol between a “receiving Gateway” and receiving G3 Fax Terminals.

Briefly, and in accordance with at least one of the foregoing objects, an embodiment of the present invention provides a method and apparatus for adjusting protocol timing in a facsimile transmission in a packet based network, wherein the network includes a receiving gateway in communication with receiving facsimile equipment. The receiving gateway transmits a TSI/DCS signal to the receiving facsimile equipment and starts a timer to determine when a pre-determined period of time has elapsed since the TSI/DCS signal has been transmitted to the receiving facsimile equipment. Once the pre-determined period of time has elapsed since the TSI/DCS signal has been transmitted to the receiving facsimile equipment, the receiving gateway either transmits a TCF transmission or a training sequence transmission to the receiving facsimile equipment. The receiving gateway also transmits image data to the receiving facsimile equipment, and thereafter delays transmittal of flags to the receiving facsimile equipment either by generating invalid scan lines or by inserting fill-bits at the end of a scan line and before the next End of Line signal.

### BRIEF DESCRIPTION OF THE DRAWINGS

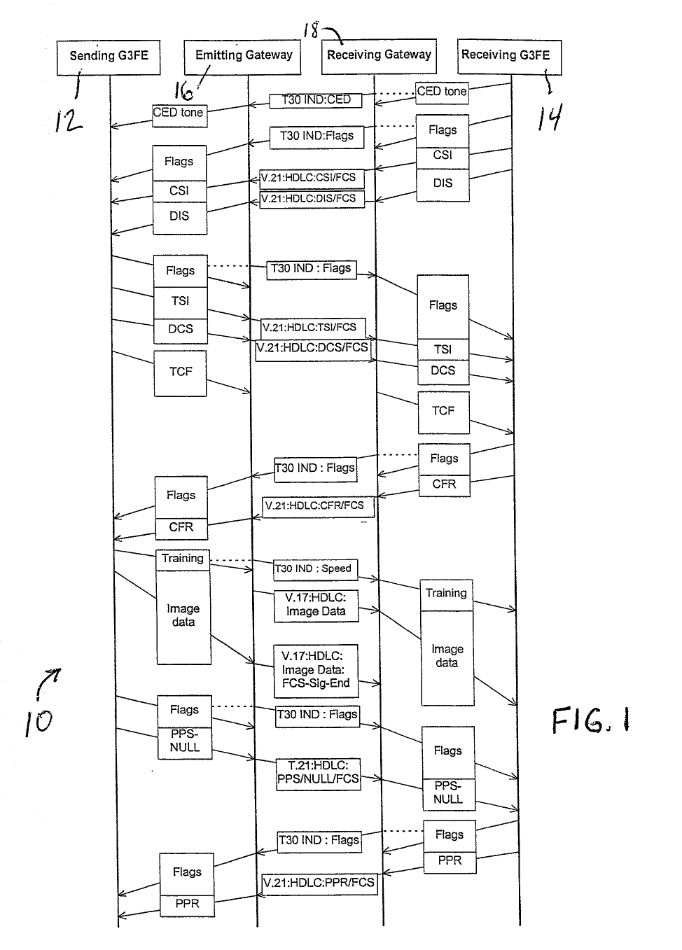

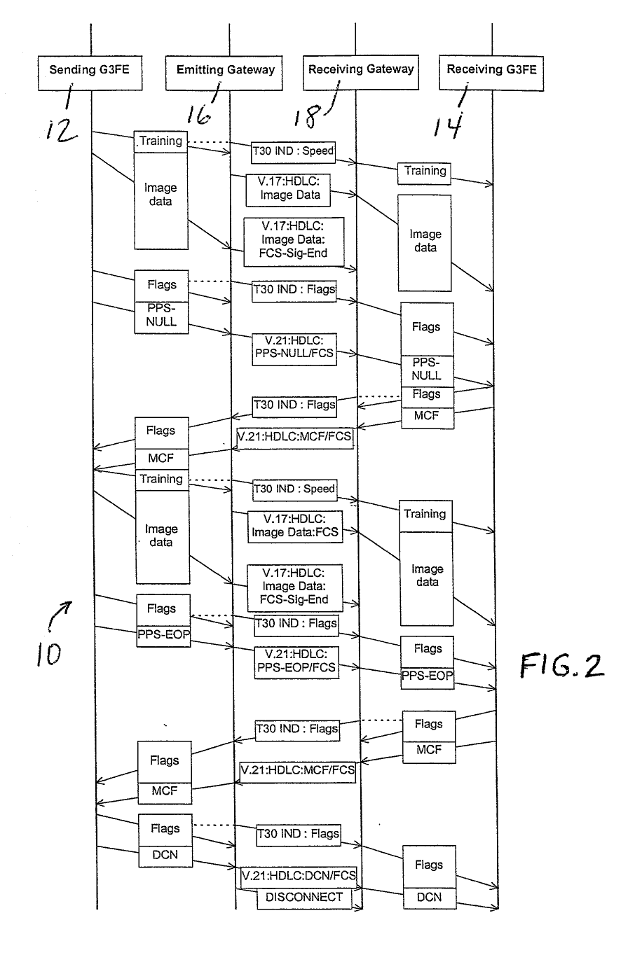

The organization and manner of the structure and operation of the invention, together with further objects and advantages thereof, may best be understood by reference to the following description, taken in connection with the accompanying drawings, wherein FIGS. 1 and 2 show a packet based network, wherein two Group 3 facsimile devices are communicating through gateways.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

The T.38 defines the procedures to allow G3 facsimile transmission between terminals where, in addition to the PSTN, a portion of the transmission path used between terminals includes an IP network, e.g. the Internet. T.38 specifies the messages and data exchanged between facsimile gateways connected via an IP network. Once the end-to-end connection is established the protocol assumes a consistent end-to-end timing will exit. However, because of the delays introduced in facsimile relay processing as well as IP routing within Internet, this is not a correct assumption. There are two areas where this problem needs to be addressed, and the present invention is directed thereto. The two areas relate to: 1) timing between end of the “Binary Coded Signal” (BCS) on the receiving gateway and the start of TCF; and timing between end of the “image data” and the generation of “Flags” for the subsequent BCS (e.g. EOP, PPS, MPS or EOM). Below, each of these areas are discussed.

1) Timing between end of the “Binary Coded Signal” (BCS) on the receiving gateway and the start of TCF.

Most facsimile machines are sensitive to the accuracy of this timing within +/−20 milliseconds and may drop the call if it is violated or take other actions that may result in the eventual failure of the facsimile relay transmission. TCF is either generated locally or it is transferred between the terminals, depending on the mode of operation to synchronize modulation rates between the gateways and G3FEs. The present invention is directed at ensuring that this timing is consistent, such as always 75 milliseconds, using early or delayed generation of training sequence.

FIGS. 1 and 2 illustrate messages being transmitted in a packet based network 10 between two G3FE's, i.e. between a sending G3FE 12 or sending facsimile equipment and a receiving G3FE 14 or receiving facsimile equipment. The messages are communicated through gateways, and FIGS. 1 and 2 illustrate an emitting gateway 16 and a receiving gateway 18. As shown in FIG. 1, the signal transmitted by the receiving gateway to the receiving G3FE 14 before TCF is TSI/DCS. After the transmission of the DCS, the receiving gateway 18 starts a timer. If the TCF is to be generated locally, then the receiving gateway 18 starts the transmission of TCF 75 milliseconds after the end of the TSI/DCS transmission. In the other mode of operation, when the TCF arrives in the form of demodulated data packets from the emitting gateway 16, if the TCF does not arrive within 75 milliseconds after the end of the TSI/DCS signal, the receiving gateway 18 starts early generation of a training sequence. The receiving gateway 18 is preferably configured to ensure that the length of the training sequence transmission to the receiving G3FE 14 is within the T.30 specification.

In the event that the demodulated training data arrives earlier than 75 milliseconds, then the demodulated training data is buffered locally by the receiving gateway 18, and the transmission of the TCF is delayed until 75 milliseconds of time has elapsed from the end of the TSI/DCS transmission.

2) Timing between end of the “image data” and the generation of “Flags” for the subsequent BCS (e.g. EOP, PPS, MPS or EOM).

The present invention is directed to ensure that this timing is consistent, such as always 75 milliseconds, using early or delayed generation of flags. Most facsimile machines are sensitive to the accuracy of this timing within +/−20 ms and may drop the call if it is violated or take other actions that may result in the eventual failure of the facsimile relay transmission. The method to delay the generation of flags may be based on one or more methods. For example, the receiving gateway 18 may be configured to generate invalid scan lines or insert fill-bits at the end of a scan line and before the next EOL (T.4 End of Line signal), or to generate flags.

As a result of the foregoing, fax quality is improved when transmitting fax over a packet based network with significant delay and packet jitter. The protocol timing is adjusted between a receiving gateway and the receiving Group 3 Facsimile Equipment (G3FE). The protocol adjustment is applied when operating facsimile transmission over Internet to increase the success rate for transmission of facsimile via T.38 or similar facsimile relay protocols, and ensures that network delay and packet jitter do no result in certain violation of timing constraints defined by the T.30 protocol between a receiving gateway and receiving G3 Fax Terminals.

The present invention may be used in, for example, the following applications/environment: voice over IP applications, compressed networks over E1/T1, satellite communications—VSATs, voice over cable modems, and other packet based networks.

While embodiments of the present invention are shown and described, it is envisioned that those skilled in the art may devise various modifications of the present invention without departing from the spirit and scope of the appended claims.

What is claimed is:

1. A method for adjusting protocol timing in a facsimile transmission in a packet based network, wherein the network includes a receiving gateway in communication with receiving facsimile equipment, said method comprising:
having the receiving gateway transmit a TSI/DCS signal to the receiving facsimile equipment;
having the receiving gateway start a timer to determine when a pre-determined period of time has elapsed since the TSI/DCS signal has been transmitted to the receiving facsimile equipment; and
once the pre-determined period of time has elapsed since the TSI/DCS signal has been transmitted to the receiving facsimile equipment, having the receiving gateway transmit a TCF transmission or a training sequence transmission to the receiving facsimile equipment.

2. A method as recited in claim 1, wherein said pre-determined period of time is 75 milliseconds.

3. A method as recited in claim 1, further comprising having said receiving gateway generate the TCF transmission.

4. A method as recited in claim 1, wherein the network includes an emitting gateway in communication with the receiving gateway and wherein said method further comprises having the receiving gateway receive the TCF transmission from the emitting gateway and if the TCF transmission is not received by the receiving gateway with the pre-determined time period, having the receiving gateway transmit the training sequence transmission to the receiving facsimile equipment.

5. A method as recited in claim 1, further comprising having the receiving gateway transmit image data to the receiving facsimile equipment and thereafter delay transmittal of flags to the receiving facsimile equipment.

6. A method as recited in claim 5, further comprising delaying the transmittal of flags by either generating invalid scan lines or by inserting fill-bits at the end of a scan line and before the next End of Line signal.

7. A method for adjusting protocol timing in a facsimile transmission in a packet based network, wherein the network includes a receiving gateway in communication with receiving facsimile equipment, said method comprising:
having the receiving gateway transmit a TSI/DCS signal to the receiving facsimile equipment;
having the receiving gateway start a timer to determine when a predetermined period of time has elapsed since the TSI/DCS signal has been transmitted to the receiving facsimile equipment; and
once the pre-determined period of time has elapsed since the TSI/DCS signal has been transmitted to the receiving facsimile equipment, having the receiving gateway transmit a TCF transmission or a training sequence transmission to the receiving facsimile equipment;
having the receiving gateway transmit image data to the receiving facsimile equipment and thereafter delay transmittal of flags to the receiving facsimile equipment by either generating invalid scan lines or by inserting fill-bits at the end of a scan line and before the next End of Line signal.

8. A method as recited in claim 7, wherein said pre-determined period of time is 75 milliseconds.

9. A method as recited in claim 7, further comprising having said receiving gateway generate the TCF transmission.

10. A method as recited in claim 7, wherein the network includes an emitting gateway in communication with the receiving gateway and wherein said method further comprises having the receiving gateway receive the TCF transmission from the emitting gateway and if the TCF transmission is not received by the receiving gateway with the pre-determined time period, having the receiving gateway transmit the training sequence transmission to the receiving facsimile equipment.

11. A receiving gateway configured to adjust protocol timing in a facsimile transmission in a packet based network, wherein the receiving gateway is configured for implementation in a packet based network wherein the receiving gateway is in communication with receiving facsimile equipment, said receiving gateway configured to transmit a TSI/DCS signal to the receiving facsimile equipment, start a timer to determine when a pre-determined period of time has elapsed since the TSI/DCS signal has been transmitted to the receiving facsimile equipment, and once the pre-determined period of time has elapsed since the TSI/DCS signal has been transmitted to the receiving facsimile equipment, transmit a TCF transmission or a training sequence transmission to the receiving facsimile equipment.

12. A receiving gateway as recited in claim 11, wherein said pre-determined period of time is 75 milliseconds.

13. A receiving gateway as recited in claim 11, wherein the receiving gateway is configured to generate the TCF transmission.

14. A receiving gateway as recited in claim 11, wherein the receiving gateway is configured for placement in communication with an emitting gateway, wherein said receiving gateway is configured to receive the TCF transmission from the emitting gateway and if the TCF transmission is not received by the receiving gateway with the pre-determined time period, transmit the training sequence transmission to the receiving facsimile equipment.

15. A receiving gateway as recited in claim 11, wherein the receiving gateway is configured to transmit image data to the receiving facsimile equipment and thereafter delay transmittal of flags to the receiving facsimile equipment.

16. A receiving gateway as recited in claim 15, wherein the receiving gateway is configured to delay the transmittal of flags by either generating invalid scan lines or by inserting fill-bits at the end of a scan line and before the next End of Line signal.

17. A receiving gateway configured to adjust protocol timing in a facsimile transmission in a packet based network, wherein the receiving gateway is configured for implementation in a packet based network wherein the receiving gateway is in communication with receiving facsimile equipment, said receiving gateway configured to transmit a TSI/DCS signal to the receiving facsimile equipment, start a timer to determine when a pre-determined period of time has elapsed since the TSI/DCS signal has been transmitted to the receiving facsimile equipment, and once the pre-determined period of time has elapsed since the TSI/DCS signal has been transmitted to the receiving facsimile equipment, transmit a TCF transmission or a training sequence transmission to the receiving facsimile equipment, said receiving gateway configured to transmit image data to the receiving facsimile equipment and thereafter delay transmittal of flags to the receiving facsimile equipment by either generating invalid scan lines or by inserting fill-bits at the end of a scan line and before the next End of Line signal.

18. A receiving gateway as recited in claim 17, wherein said receiving gateway is configured to generate the TCF transmission.

19. A receiving gateway as recited in claim 17, wherein the receiving gateway is configured for placement in communication with an emitting gateway, wherein said receiving gateway is configured to receive the TCF transmission from the emitting gateway and if the TCF transmission is not received by the receiving gateway with the predetermined time period, transmit the training sequence transmission to the receiving facsimile equipment.
